(19) United States
(12) Patent Application Publication
(10) Pub. No.: US 2005/0078979 A1
(43) Pub. Date: Apr. 14, 2005

(54) Organic photoconductive drum assembly

(76) Inventors: Yong-baek Yoo, Suwon-si (KR); Chung-guk Baek, Suwon-si (KR)

Correspondence Address: STANZIONE & KIM, LLP, 1740 N STREET, N.W., FIRST FLOOR, WASHINGTON, DC, 20036, US

(21) Appl. No.: 10/834,266

(22) Filed: Apr. 29, 2004

(30) Foreign Application Priority Data
Oct. 13, 2003 (KR) 2003-70966

(51) Int. Cl. G03G 15/00

(52) U.S. Cl. 399/117; 399/159

(57) ABSTRACT

An organic photoconductive (OPC) drum assembly including a pipe-shaped drum body with open sides, first and second flanges connected to both sides of the drum body, a shaft penetrating the drum body and rotatably supporting the flanges, and a pair of bearings inserted between each flange and the shaft. A driving gear to receive power is integrally formed with one of the first and second flanges.

### CROSS-REFERENCE TO RELATED APPLICATIONS

This application claims the benefit of Korean Patent Application No. 2003-70966 filed Oct. 13, 2003, in the Korean Intellectual Property Office, the disclosure of which is incorporated herein by reference.

### BACKGROUND OF THE INVENTION

1. Field of the Invention

The present invention relates to an organic photoconductive (OPC) drum assembly to form an image to be transferred onto a transfer medium.

2. Description of the Related Art

As generally known in the art, a printing machine such as a laser printer or a photocopier includes a photoreceptor unit to development images.

A photoreceptor unit is operational for a limited period of time and requires replacement at the end of its life cycle in order to develop and produce clean images. To facilitate replacement, a photoreceptor unit is generally modularized so as to be replaceable as a whole with a new one.

A modularized photoreceptor unit may include a photoconductive drum assembly, a housing for enclosing and protecting part of the photoconductive drum assembly, and a handgrip.

The photoconductive drum assembly is required to be configured to receive power for rotation within a printer housing.

When the photoreceptor unit is mounted into the printer housing, it cannot easily self-compensate for assembly errors. Therefore, the photoconductive drum assembly needs to have a gap compensating design to account for assembly errors.

### SUMMARY OF THE INVENTION

Accordingly, it is an aspect of the present invention to solve the above and/or other drawbacks and problems associated with the conventional arrangements by providing an organic photoconductive (OPC) drum assembly with an improved structure which receives power and has a gap compensating design to account for assembly errors.

Additional aspects and advantages of the invention will be set forth in part in the description which follows and, in part, will be obvious from the description, or may be learned by practice of the invention.

The foregoing and/or other aspects of the present invention are achieved by providing an organic photoconductive drum assembly including: a pipe-shaped drum body with open sides; first and second flanges connected to both sides of the drum body; a shaft penetrating the drum body to rotatably support the flanges; and a pair of bearings inserted between each flange and the shaft. A drum gear capable of receiving power can be integrated with any one of the first and second flanges.

In an aspect of the present invention, the drum gear can have a smaller outer diameter than the flange it is integrated with.

In another aspect of the present invention, each of the first and second flanges can include: a shaft hole into which the shaft can penetrate; and a bearing-receiving groove cut into the outer surface of each flange by a predetermined depth to receive a bearing. In another aspect of the present invention, the bearing-receiving groove can have a depth of less than half of the thickness of each flange.

In another aspect of the present invention, the shaft can have small diameter sections inserted into the bearings at both ends thereof and a large diameter section between the small diameter sections.

It is also possible to form an additional small diameter section having stepped boundaries between the large diameter section and the small diameter sections formed at both ends of the shaft.

In yet another aspect of the present invention, the distance between the small diameter sections can be shorter than the distance between the bearings to ensure a gap to allow the shaft to move by a predetermined distance in an axial direction of the drum body.

The foregoing and/or other aspects of the present invention are also achieved by providing a photoconductive drum assembly including a drum body including a first end opening and a second end opening. A first flange can be arranged in the first end opening of the drum body and can include a first bearing receiving groove. A second flange can be arranged in the second end opening of the drum body and can include a second bearing receiving groove. A first bearing can be arranged in the first bearing receiving groove and a second bearing can be arranged in the second bearing receiving groove. A shaft can extend through the drum body and can rotatably support the drum assembly along an axis by way of the first bearing and the second bearing and can move with respect to the drum body along the axis of the drum assembly.

The foregoing and/or other aspects of the present invention are also achieved by providing a method of thrust compensation in a photoconductive drum assembly having a drum body, a shaft in which the drum body axially rotates around, and a drum gear to rotate the drum body. The method can include applying a power to the drum gear to rotate the drum body and moving the drum body with respect to the shaft to compensate for a thrust generated by the power applied to the drum gear.

### BRIEF DESCRIPTION OF THE DRAWINGS

These and other objects and advantages of the present invention will become apparent and more readily appreciated from the following description of the embodiments, taken in conjunction with the accompanying drawings of which:

FIG 1 is a perspective view of a photoreceptor unit with a photoconductive drum assembly according to an embodiment of the present invention;

FIG. 2 is an exploded perspective view of a photoconductive drum assembly according to the embodiment of FIG. 1;

FIGS. 3A and 3B are cross-sectional views of the photoconductive drum assembly shown in FIG. 2; and

FIG. 4 is a plan view of the shaft shown in FIG. 2 according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

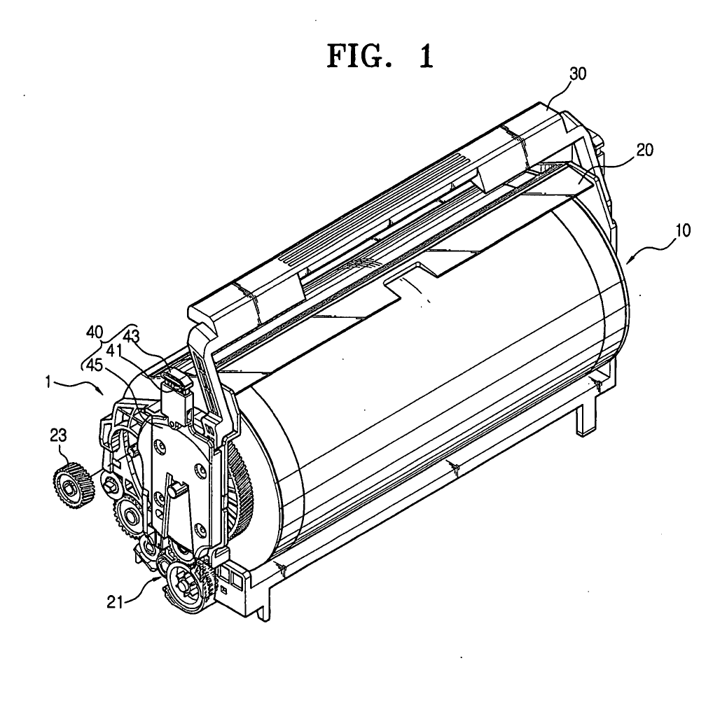

FIG. 1 is a perspective view of a photoreceptor unit 1 with a photoconductive drum assembly 10 according to one embodiment of the present invention. Referring to FIG. 1, the photoconductive drum assembly 10 is partially surrounded by a printer housing 20.

A handgrip 30 is rotatably connected to the housing 20. A user can raise the handgrip 30 to lift up the photoreceptor unit 1. The handgrip 30 can be lowered to its original position when the photoreceptor unit 1 is mounted back in its original position. A damping member 40 can include a spring 41, a damping bar 43 and a bracket 45. The damping member 40 elastically supports a transfer unit (not shown) placed on top of a photoreceptor unit 1 within a mainframe of the printer housing 20.

A gear train 21 with a plurality of gears is provided on one side of the housing 20. The gear train 21 is connected to the photoconductive drum assembly 10 so that it can operate by power received from the photoconductive drum assembly 10. The gear train 21 is provided to drive an auger (not shown) and a cleaning roller (not shown) for cleaning an electrification roller (not shown).

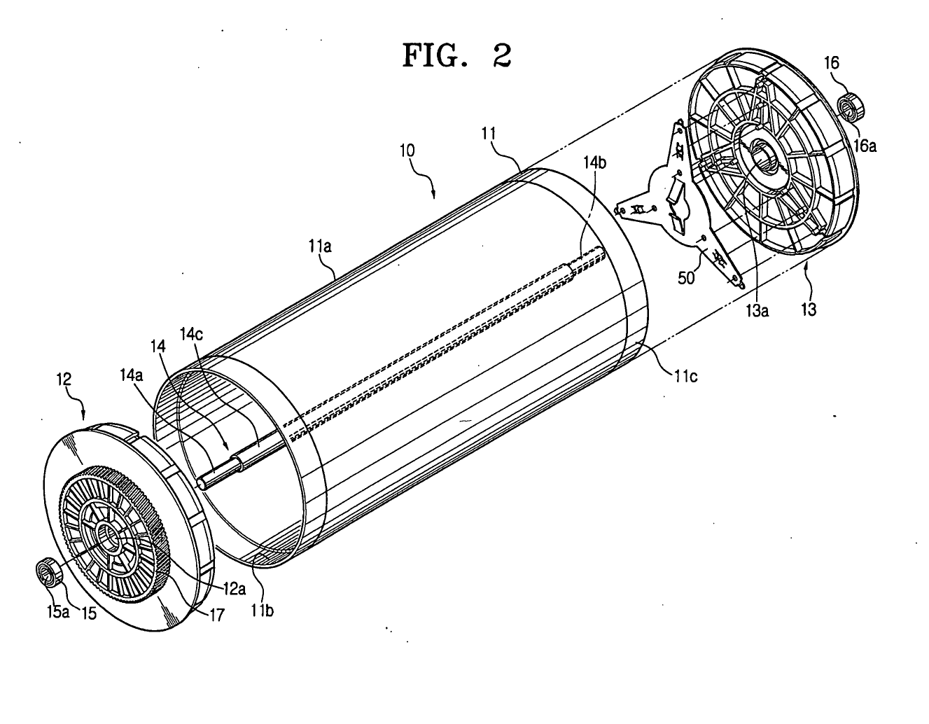

As shown in FIG. 2, the photoconductive drum assembly 10 includes a drum body 11, first and second flanges 12 and 13 connected respectively to both sides of the drum body 11, a shaft 14 to rotatably support the flanges 12 and 13, and bearings 15 and 16 inserted between the shaft 14 and each of the flanges 12 and 13.

The drum body 11 can be substantially pipe shaped with open sides. The drum body 11 may be made of aluminum to achieve electrical conductivity and provide a light-weight, high strength design. A photoconductive layer 11 a is formed on a part (for example, the image forming part) of the outer periphery of the drum body 11. The photoconductive layer 11a can be a photosensitive material that is coated on the drum body 11 or a photoconductive film that is attached to the drum body 11.

The drum body 11 has connecting parts 11b and 11c at the inner peripheries of both ends thereof. The first and second flanges 12 and 13 can be forcibly inserted into the connecting parts 11b and 11c, respectively. The connecting parts 11b and 11c can be formed by broadening the inside diameter of the drum body 11 at its ends by a predetermined width.

Once inserted into the connecting parts 11b and 11c of the drum body 11, the flanges 12 and 13 rotate together with the drum body 11. The flanges 12 and 13 can be made of plastic and have shaft holes 12a and 13a into which the shaft 14 can be inserted. A drum gear 17 that can receive power from the mainframe of the printer housing 20 is integrated into the outer surface of the first flange 12. The drum gear 17 has a smaller diameter than the flange 12. Since the drum gear 17 and the first flange 12 are integrated as a single body, the cost of manufacture and the assembly gap can be both reduced.

Once inserted into the connecting parts 11b and 11c of the drum body 11, the flanges 12 and 13 rotate together with the drum body 11. The flanges 12 and 13 can be made of plastic and have shaft holes 12a and 13a into which the shaft 14 can be inserted. A drum gear 17 that can receive power from the mainframe of the printer housing 20 is integrated into the outer surface of the first flange 12. The drum gear 17 has a smaller diameter than the flange 12. Since the drum gear 17 and the first flange 12 are integrated as a single body, the cost of manufacture and the assembly gap can be both reduced.

Also, the drum gear 17 and the drum body 11 rotate together, thereby reducing power transfer losses. The drum gear 17 is connected to the gear train 21 to transfer power.

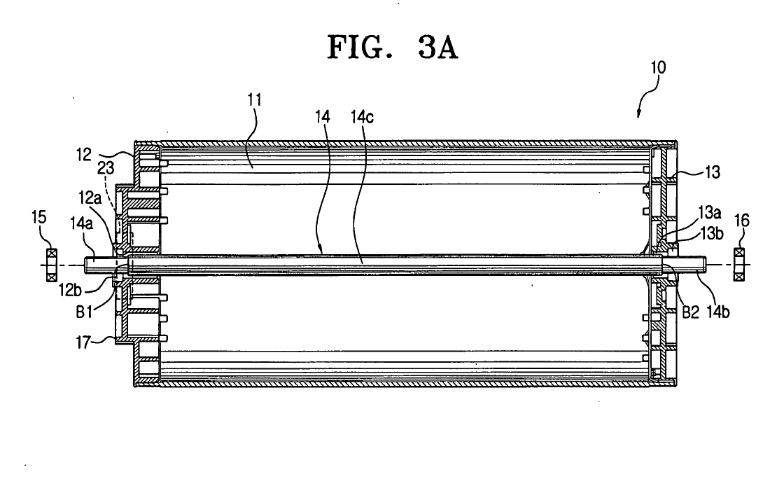

As shown in FIG. 3A, the flanges 12 and 13 have bearing-receiving grooves 12b and 13b which are formed coaxially with the shaft holes 12a and 13a. The bearing-receiving grooves 12b and 13b are formed coaxially with the shaft holes 12a and 13a by cutting into the outer surfaces of the flanges 12 and 13 by a predetermined depth. The bearing-receiving grooves 12b and 13b may have a greater diameter than the shaft holes 12a and 13b. In another example, the bearing-receiving grooves 12b and 13b may have a depth of less than half of the thickness of the flanges 12 and 13 so that the bearings 15 and 16 can be inserted or removed only from the outer sides of the flanges 12 and 13. Such a structure can prevent the bearings 15 and 16 from releasing into the interior of the drum body 11. When the bearings 15 and 16 are inserted into the bearing-receiving grooves 12b and 13b, the brackets 45 (shown in FIG. 1), coupled to both sides of the housing 20, interfere with and prevent the bearings 15 and 16 from being released from the bearing-receiving grooves 12b and 13b.

The shaft 14 is coupled to the bearings 15 and 16 that are inserted into the bearing-receiving grooves 12b and 13b. The shaft 14 has, at both ends thereof, small diameter sections 14a and 14b which are inserted into axial holes 15a and 16a (shown in FIG. 2) of the bearings 15 and 16. The shaft 14 also has a large diameter section 14c between the small diameter sections 14a and 14b. The large diameter section 14c has a larger external diameter than the small diameter sections 14a and 14b. Accordingly, stepped boundaries B1 and B2 are formed between the large diameter section 14c and each of the small diameter sections 14a and 14b in order to prevent the shaft 14 from passing through the bearings 15 and 16 and slipping out from the drum body 11.

Referring to FIG. 3B, the distance L1 between the stepped boundaries B1 and B2 is shorter than the distance L2 between the bearing-receiving grooves 12b and 13b to provide a gap G. Due to the gap G between the distances L1 and L2, the shaft 14 can move by a predetermined distance in the axial direction while being inserted into the bearings 15 and 16.

The gap G corresponds to the difference between the distance L1 and the distance L2. The flanges 12 and 13 and the bearings 15 and 16 move integrally with each other due to the presence of the gap G. When power is applied to the drum gear 17 from a driving gear 23, the drum body 11 moves in a direction towards the drum gear 17 along a distance defined by the gap G and subsequently causes the generation of a thrust. The drum gear 17 and the driving gear 23 are helical gears so that they can direct the thrust in a predetermined direction when they are driven in relation to each other. The drum body 11 is moveable by the thrust in a direction towards the drum gear 17 and along the distance defined by the gap G The drum gear 17 moves together with the drum body 11 due to the thrust. FIG. 3A shows a condition before the generation of the thrust, and FIG. 3B shows the gap G as the drum body 11, the drum gear 17 and the bearings 15 and 16 are moved by the thrust. As shown in FIG. 3B, the gap G is provided in order to compensate for the thrust generated by the driving of the gears 17 and 23, and to subsequently allow the driven photosensitive drum 11 to be thrust in a single, predetermined direction. As a result, the movement of the photosensitive drum 11 is well controlled such that images are developed precisely on a predetermined location of the drum body 11.

In FIG. 2, a grounding element 50 can be provided on the inner surface of the second flange 13 to allow an electrical connection to be formed between the drum body 11 and the shaft 14.

In the photoconductive drum assembly 10 according to this embodiment of present invention, the driving gear 17 to recieve power can be integrated into the flange 12. Thus, it is possible to reduce the cost of manufacture and assembly error.

Since the bearing-receiving grooves 12b and 13b are formed by cutting into the outer surfaces of the flanges 12 and 13 by a predetermined depth, it is possible to prevent the bearings 15 and 16 from releasing towards the inner sides of the flanges 12 and 13, i.e., into the drum body 11. In other words, the bearing-receiving grooves 12b and 13b stably support the bearings 15 and 16, thereby ensuring the stable driving of the photoconductive drum assembly 10.

The small diameter sections 14a and 14b of the shaft 14 are formed at both ends of the shaft 14 and are stepped with respect to the large diameter section 14c, thereby preventing the shaft 14 from slipping out from the photoconductive drum assembly 10. Also, the gap G allows the shaft 14 to move a predetermined distance in the axial direction to correct any assembly error and ensure stability of the photoconductive drum assembly 10. Furthermore, because the gap G allows the drum body 11 to move along the shaft 14 by a predetermined distance, the thrust, which is generated by the drum gear 17 and the driving gear 23, can be compensated for.

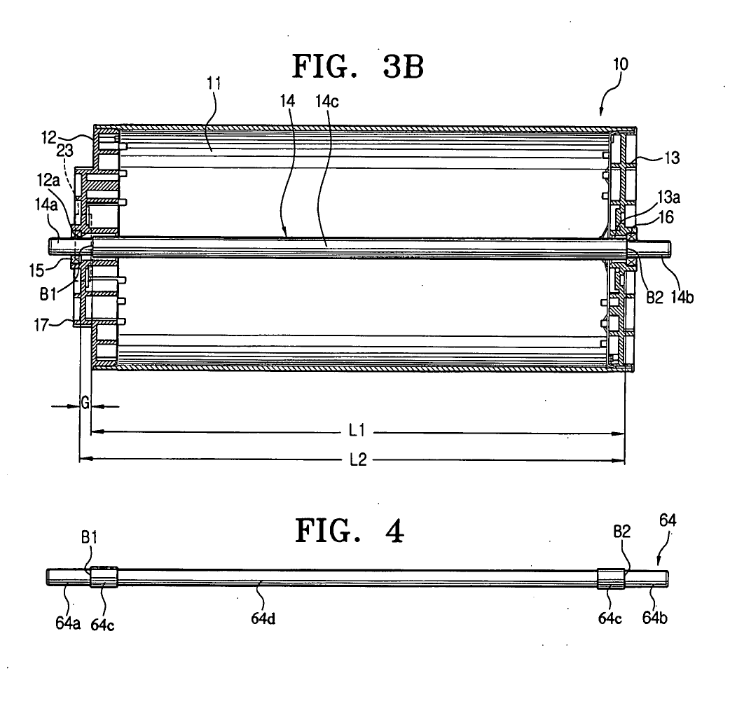

FIG. 4 shows a shaft 64 in a photoconductive drum assembly according to another embodiment of the present invention.

Referring to FIG. 4, the shaft 64 has large diameter sections 64c between small diameter sections 64a and 64b formed at both ends thereof. The shaft 64 also has another small diameter section 64d between stepped boundaries B1 and B2 formed between the large diameter sections 64c and the small diameter sections 64a and 64b. The small diameter section 64d is formed by reducing the diameter of a large diameter section excluding the end portions. By providing the additional small diameter section 64d, it is possible to use less material and reduce the weight of the shaft 14. Due to the formation of the additional small diameter section 64d, the shaft 14 consequently has a pair of large diameter sections 64c.

According to the present invention, a driving gear 17 is formed integrally with the flange 12, thereby simplifying the structure of the photoconductive drum assembly 10 and reducing the tolerance in assembly and manufacture.

Since the bearings 15 and 16 can be inserted or released only from the outer sides of the flanges 12 and 13, it is possible to stably support the photoconductive drum assembly 16 and prevent the bearings 15 and 16 from releasing into the inside of the drum body 11.

Also, the small diameter sections 14a and 14b formed at both ends of the shaft 14 can prevent the shaft 14 from slipping out from the photoconductive drum assembly 10 and provide for the formation of a gap G to allow the shaft to move by a predetermined distance in the axial direction.

According to the embodiments discussed above, thrust compensation can be achieved by forming a gap G between the shaft 14 and the drum body 11. However, it should be noted that this is only an example, and other adequate variations which provide the intended results of the present invention can be alternatively incorporated. For example, a gap can be arranged between the flange 12 coupled to the drum body 11 and the inner side of the housing 20 to control the generation of thrust.

Although preferred embodiments have been described for illustrative purposes, the present invention is not to be unduly limited to the configuration or operation set forth herein. Those skilled in the art will appreciate that various modifications, additions and substitutions are possible, without departing from the scope and spirit of the invention as disclosed in the accompanying claims.

1. An organic photoconductive drum assembly comprising:
a pipe-shaped drum body including a first end opening and a second end opening;
first and second flanges connectable with the drum body through the first and second end openings, respectively;
a shaft extending through the drum body and rotatably supporting the first and second flanges;
first and second bearings arranged between the first flange and the shaft and the second flange and the shaft, respectively; and
a drum gear integrally formed with one of the first and second flanges to receive a driving power.

2. The drum assembly according to claim 1, wherein the drum gear has a smaller outer diameter than the integrally formed flange.

3. The drum assembly according to claim 1, wherein the first and second flanges each include:
a shaft hole extending through each flange to receive and end of the shaft; and
a bearing-receiving groove arranged in an outer surface of the respective first and second flanges co-axially with the respective shaft hole and extending a predetermined depth into the first and second flanges to receive the respective first and second bearings.

4. The drum assembly according to claim 3, wherein the bearing-receiving groove of each of the first and second flanges has a depth of less than half of a thickness of the respective flange.

5. The drum assembly according to claim 1, wherein the shaft includes small diameter sections at each end thereof forming a stepped boundary with a large diameter section between the small diameter sections, each small diameter section having a diameter corresponding to axial holes formed in the first and second bearings.

6. The drum assembly according to claim 5, wherein the shaft includes an additional small diameter section formed between the stepped boundaries.

7. The drum assembly according to claim 5, wherein a distance between the small diameter sections is shorter than a distance between the first and second bearings to provide a gap to allow the shaft to move a predetermined distance in an axial direction of the drum body.

8. The drum assembly according to claim 1, wherein the drum gear is formed of a helical shape to provide a thrust when driven.

9. The drum assembly according to claim 3, wherein the bearing-receiving grooves have a greater diameter than the shaft holes to prevent the respective bearings from entering into the drum body.

10. The drum assembly according to claim 3, wherein the bearing-receiving grooves have a depth of less than half of the thickeness of the respective flange so that the respective bearing can be inserted and removed only from outer sides of the respective flanges.

11. The drum assembly according to claim 8, wherein the first and second flanges and the first and second bearings move integrally with each other due to the thrust created when the drum gear is driven.

12. The drum assembly according to claim 1, further comprising a ground element positioned on an inner surface of one of the first and second flanges to provide an electrical connection between the drum body and the shaft.

13. A photoconductive drum assembly comprising:
a drum body including a first end opening and a second end opening;
a first flange arranged in the first end opening of the drum body, the first flange including a first bearing receiving groove;
a second flange arranged in the second end opening of the drum body, the second flange including a second bearing receiving groove;
a first bearing arranged in the first bearing receiving groove and a second bearing arranged in the second bearing receiving groove; and
a shaft extending through the drum body and rotatably supporting the drum assembly along an axis of the drum body extending through the first and second bearings;
wherein the shaft moves with respect to the drum body along the axis of the drum body.

14. The drum assembly of claim 13, wherein the shaft includes first and second small diameter sections at each end of the shaft and a large diameter section between the first and second small diameter sections thereby forming first and second stepped boundaries at an intersection of respective ends of the large diameter section and the first and second small diameter sections.

15. The drum assembly of claim 13, wherein a first distance defined between the first and second stepped boundaries of the shaft is shorter than a second distance defined between innermost portions of the first and second bearing receiving grooves to allow movement between the shaft and the drum body.

16. The drum assembly of claim 13, wherein a drum gear is integrally formed with one of the first and second flanges.

17. The drum assembly of claim 16, wherein the drum gear is a helical gear.

18. The drum assembly of claim 13, wherein at least one of the bearing receiving grooves is arranged in an outer surface of its respective flange and extends a predetermined depth into the flange.

19. The drum assembly of claim 18, wherein the predetermined depth of the at least one bearing receiving groove is less than half of a thickness of its respective flange.

20. The drum assembly of claim 18, further comprising an axial hole having a smaller diameter than the at least one bearing receiving groove to define the predetermined depth of the at least one bearing receiving groove and to prevent one of the first and second bearings arranged in the at least one bearing groove from falling into an interior of the drum body.

21. The drum assembly of claim 13, wherein the shaft includes:
first and second small diameter end sections at each end of the shaft;
first and second large diameter sections located adjacent to the respective first and second small diameter end sections, each of the first and second large diameter sections forming a stepped boundary with the adjacent respective first and second small diameter end sections; and
a third small diameter section being arranged between each stepped boundary.

22. A method of thrust compensation in a photoconductive drum assembly having a drum body, a shaft in which the drum body axially rotates around, and a drum gear to rotate the drum body, the method comprising:
applying a power to the drum gear to rotate the drum body; and
moving the drum body with respect to the shaft to compensate for a thrust generated by the power applied to the drum gear.

23. The method of claim 22, further comprising meshing a rotating driving gear with the drum gear to provide the applying power to the drum gear.

24. The method of claim 22, wherein the moving of the drum body to compensate for the thrust includes moving the drum body in the axially rotating direction along a predetermined distance.
